(19) United States
(12) Patent Application Publication
(10) Pub. No.: US 2018/0178711 A1
(43) Pub. Date: Jun. 28, 2018

(54) VEHICLE HEADLIGHT CONTROL

(71) Applicant: Harman International Industries, Incorporated, Stamford, CT (US)

(72) Inventors: Junhao Wang, Shanghai (CN); Qingshan Zhang, Shanghai (CN)

(73) Assignee: Harman International Industries, Incorporated, Stamford, CT (US)

(21) Appl. No.: 15/526,295

(22) PCT Filed: Dec. 18, 2014
(86) PCT No.: PCT/CN2014/094194

§ 371 Date: May 11, 2017

(51) Int. Cl. B60Q 1/14; B60Q 9/00

(52) U.S. Cl. CPC B60Q 1/1423; B60Q 2300/23; B60Q 2300/47; B60Q 9/00

(57) ABSTRACT

Method and system for controlling vehicle headlights are provided. The method includes: controlling headlights of a first vehicle based on position and heading direction information of vehicles in the vicinity of the first vehicle received over a vehicle to vehicle communications network. The system includes: a communication device, and a processing device configured to control headlights of a first vehicle based on position and heading direction information of vehicles in the vicinity of the first vehicle received by the communication device over a vehicle to vehicle communications network. The vehicle headlights control method and system are precise and smooth.

### TECHNICAL FIELD

The present disclosure generally relates to vehicle headlight control.

### BACKGROUND

Improper operations of vehicle headlights can cause fatal accidents, especially high beams. For example, a sudden switch from low beam to high beam may temporarily blind other drivers.

### SUMMARY

In one embodiment, a method for controlling vehicle headlights is provided. The method may include: controlling headlights of a first vehicle based on position and heading direction information of vehicles in the vicinity of the first vehicle received over a vehicle to vehicle communications network.

In some embodiments, the method may further include: controlling the headlights of the first vehicle if a second vehicle, whose position and heading direction relative to the first vehicle meets a pre-set criteria, is identified based on the received position and heading direction information, where view of a driver of a vehicle that meets the pre-set criteria will be substantially affected by high beams of the first vehicle.

In some embodiments, the method may further include: turning off high beams of the first vehicle if the second vehicle is identified meeting the pre-set criteria.

In some embodiments, the method may further include: turning on low beams of the first vehicle when the high beams of the first vehicle are turned off.

In some embodiments, the method may further include: controlling emitting directions of the high beams of the first vehicle based on a distance between the first vehicle and the second vehicle if the second vehicle is identified meeting the pre-set criteria, wherein the distance is calculated based on the position information of the second vehicle received over the vehicle to vehicle communications network and position information of the first vehicle.

In some embodiments, the pre-set criteria may include a pre-set distance and a pre-set heading direction relationship between the first vehicle and the second vehicle.

In some embodiments, the pre-set heading direction relationship may include head passing and rear driving. Head passing represents that the first vehicle and the second vehicle are approaching each other along opposite directions. Rear driving represents that the first vehicle and the second vehicle are moving in the same direction, and the first vehicle is behind the second vehicle.

In some embodiments, the method may further include: controlling the high beams of the first vehicle based on size and type information of the second vehicle received over the vehicle to vehicle communications network.

In some embodiments, the method may further include: controlling emitting directions of the high beams of the first vehicle based on positions of eyes of a driver of the second vehicle or positions of rearview mirrors of the second vehicle, which may be estimated by the size and the type information of the second vehicle.

In one embodiment, a method for controlling vehicle headlights is provided. The method may include: reminding a driver of a first vehicle to turn off high beams when a second vehicle, whose position and heading direction relative to the first vehicle meets a pre-set criteria, is identified based on position and heading direction information of vehicles in the vicinity of the first vehicle received over a vehicle to vehicle communications network.

In some embodiments, the pre-set criteria may include a pre-set distance and a pre-set heading direction relationship between the first vehicle and the second vehicle.

In one embodiment, a system for controlling vehicle headlights is provided. The system may include a communication device and a processing device, wherein the communication device is for receiving position and heading direction information of vehicles in the vicinity of a first vehicle over a vehicle to vehicle communications network, and the processing device is configured to: control headlights of the first vehicle based on the received position and heading direction information.

In some embodiments, the processing device may be further configured to: control the headlights of the first vehicle if a second vehicle, whose position and heading direction relative to the first vehicle meets a pre-set criteria, is identified based on the received position and heading direction information.

In some embodiments, the processing device may be further configured to: control to turn off high beams of the first vehicle if the second vehicle is identified meeting the pre-set criteria.

In some embodiments, the processing device may be further configured to: control to turn on low beams of the first vehicle when the high beams of the first vehicle are turned off.

In some embodiments, the processing device may be further configured to: control emitting directions of the high beams of the first vehicle based on a distance between the first vehicle and the second vehicle if the second vehicle is identified meeting the pre-set criteria, wherein the distance is calculated based on the position information of the second vehicle received over the vehicle to vehicle communications network and position information of the first vehicle.

In some embodiments, the pre-set criteria may include a pre-set distance and a pre-set heading direction relationship between the first vehicle and the second vehicle.

In some embodiments, the pre-set heading direction relationship may include head passing and rear driving.

In some embodiments, the processing device may be further configured to: control the headlights of the first vehicle based on size and type information of the second vehicle received by the communication device over the vehicle to vehicle communications network.

In some embodiments, the processing device may be further configured to: control emitting directions of the high beams of the first vehicle based on positions of eyes of a driver of the second vehicle or positions of rearview mirrors of the second vehicle, which may be estimated by the size and the type information of the second vehicle.

In one embodiment, a system for reminding driver to turn off high beams is provided. The system may include a communication device, a reminder presenting device and a processing device, wherein the communication device is for receiving position and heading direction information of vehicles in the vicinity of a first vehicle over a vehicle to vehicle communications network, and the processing device is configured to: control the reminder presenting device to present a reminder to a driver of the first vehicle to turn off the high beams when a second vehicle, whose position and heading direction relative to the first vehicle meets a pre-set criteria, is identified based on the received position and heading direction information.

In some embodiments, the pre-set criteria may include a pre-set distance and a pre-set heading direction relationship between the first vehicle and the second vehicle.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a vehicle-to-vehicle communication between a first vehicle and a second vehicle;

FIG. 2 schematically illustrates a system for vehicle headlights control according to one embodiment;

FIG. 3 schematically illustrates a method for vehicle headlights control according to one embodiment;

FIG. 4 schematically illustrates a first heading direction relationship between a first vehicle and a second vehicle;

FIG. 5 schematically illustrates a second heading direction relationship between the first vehicle and the second vehicle;

FIG. 6 schematically illustrates a system for vehicle headlights control according to one embodiment; and

FIG. 7 schematically illustrates a method for vehicle headlights control according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

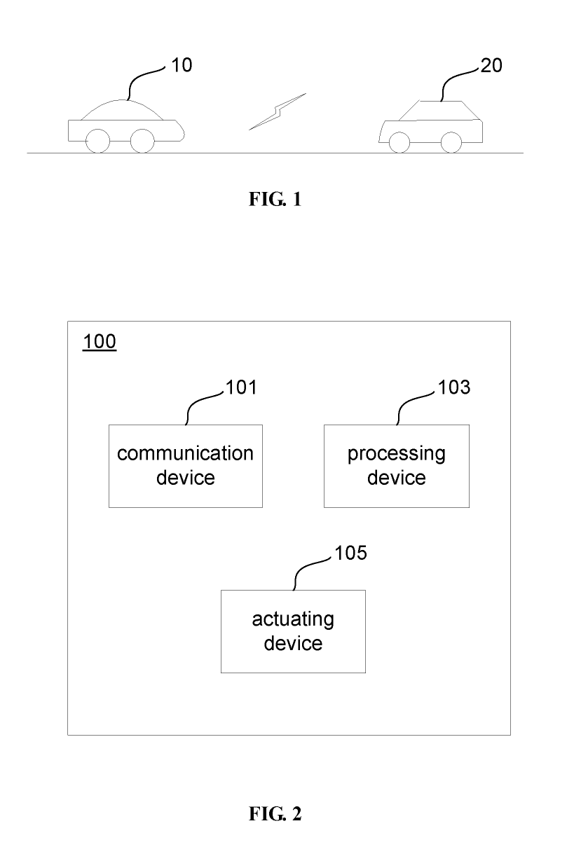

FIG. 1 schematically illustrates a vehicle-to-vehicle (V2V) communication between a first vehicle and a second vehicle.

As shown in FIG. 1, through a V2V communications network, a first vehicle 10 and a second vehicle 20 are able to communicate with each other. There are various kinds of V2V communication standards and/or protocols, which are mainly for vehicle safety application. For example, information of the second vehicle 20 may be carried in a Basic Safety Message (BSM), a Cooperative Awareness Message (CAM), or the like. As such, information of the second vehicle 20, such as position, heading direction, size, type, and velocity of the second vehicle 20, can be transmitted to the first vehicle 10, vice versa.

Accordingly, at least a distance and a heading direction relationship between the first vehicle 10 and the second vehicle 20 can be calculated based on the information of the second vehicle 20 received over the V2V communications network. Then the distance and the heading direction relationship can be further used for vehicle headlights control.

It should be noted that, there may be more than one vehicle in the vicinity of the first vehicle. In other words, the first vehicle may receive position and heading direction information of a number of vehicles in the vicinity of the first vehicle over the V2V communications network.

Referring to FIG. 2, a system 100 for controlling vehicle headlights is illustrated. The system 100 may be mounted on the first vehicle 10 for controlling headlights of the first vehicle 10 based on information of the second vehicle 20 received over a V2V communications network.

The system 100 includes: a communication device 101 which is adapted to receiving information of the second vehicle 20 over a V2V communications network; a processing device 103 which is configured to calculate a distance and a heading direction relationship between the first vehicle 10 and the second vehicle 20 based on position and heading direction information of the second vehicle 20 received over the V2V communications network, and generate an instruction; and an actuating device 105 which is adapted to control the headlights of the first vehicle according to the instruction generated by the processing device 103.

It should be noted that, not all the components of the system 100 are necessarily mounted on the first vehicle 10. For example, in some embodiments, the processing device 101 of the system 100 may be disposed on a server. As long as the server can communicate with the first vehicle 10, such as through wireless communication, the processing device 101 can obtain the information received by the communication device 101 and the instruction generated by the processing device 101 can be delivered to the actuating device 105.

Hereafter a process for controlling the headlight of the first vehicle 10 will be illustrated in detail, which may be implemented by the system 100. Detail configurations of the system 100 will be more clear with reference to the following descriptions.

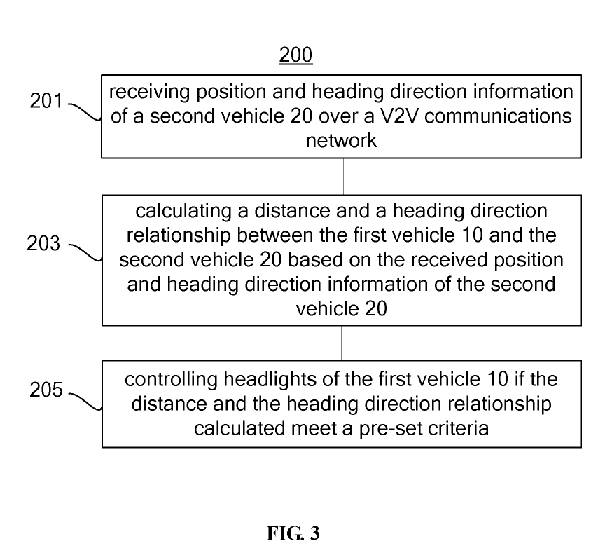

FIG. 3 schematically illustrates a process 200 for controlling the headlights of the first vehicle 10 according to one embodiment.

Referring to FIG. 3, in S201, receiving position and heading direction information of a second vehicle 20 over a V2V communications network.

In some embodiments, receiving the position and heading direction information may be implemented by the communication device 101 (as shown in FIG. 2).

In S203, calculating a distance and a heading direction relationship between the first vehicle 10 and the second vehicle 20 based on the received position and heading direction information of the second vehicle 20.

In some embodiments, calculating the distance and the heading direction relationship may be implemented by the processing device 103 (as shown in FIG. 2). In some embodiments, calculating the distance and the heading direction relationship between the first vehicle 10 and the second vehicle 20 may be implemented in a server.

In some embodiments, calculating the distance between the first vehicle 10 and the second vehicle 20 may be based on the position information of the second vehicle 20 received over the V2V communications network and position information of the first vehicle 10. Position information represents where the first/second vehicle is located. Position information of the first vehicle 10 may be obtained from on-board sensor thereof, which is well known in the art.

Similarly, calculating the heading direction relationship between the first vehicle 10 and the second vehicle 20 may be based on the heading direction information of the second vehicle 20 received over the V2V communications network and heading direction information of the first vehicle 10 which may be obtained from on-board sensor thereof.

In some embodiments, calculating the distance may be further based on the velocity and the heading direction of the second vehicle 20 received over the V2V communications network and velocity and heading direction information of the first vehicle 10. Specifically, once the distance between the first vehicle 10 and the second vehicle 20 at one time point is calculated, a dead reckoning method can be used for updating the distance continuously based on the velocity and heading direction information of the first vehicle 10 and the second vehicle 20. Velocity information of the first vehicle 10 may be obtained from on-board sensor of the first vehicle 10 as well.

In S205, controlling headlights of the first vehicle 10 if the distance and heading direction relationship calculated meet a pre-set criteria.

In some embodiments, the pre-set criteria may include a pre-set distance and a pre-set heading direction relationship.

In some embodiments, the pre-set distance may include a threshold distance or a distance range. Accordingly, the distance calculated meets the pre-set distance may refer to the distance calculated is smaller than the threshold distance or falls into the distance range.

In some embodiments, the pre-set heading direction relationship may include a head passing or a rear driving. Head passing represents that the first vehicle 10 and the second vehicle 20 are approaching each other along opposite directions. Rear driving represents that the first vehicle 10 and the second vehicle 20 are running in the same direction, and the first vehicle 10 is behind the second vehicle 20.

In some embodiments, controlling headlights of the first vehicle 10 may be implemented by the actuating device 105 (as shown in FIG. 2). Based on the distance and heading direction relationship, the actuating device 105 may turn off high beams of the first vehicle or change one or more parameters of the headlights, such as emitting direction, light intensity, illumination range, etc. For example, the emitting directions of the headlights may be controlled by controlling a direction of a reflector of the headlight. The range of light beams may be controlled by controlling a positional relationship between a filament and focus of the reflector of the headlight. Specifically, when the filament of the headlight is on the focus of the reflector, the light beams have a smaller range. Thus the range of the light beams may be enlarged by controlling the filament of the headlight away from the focus of the reflector.

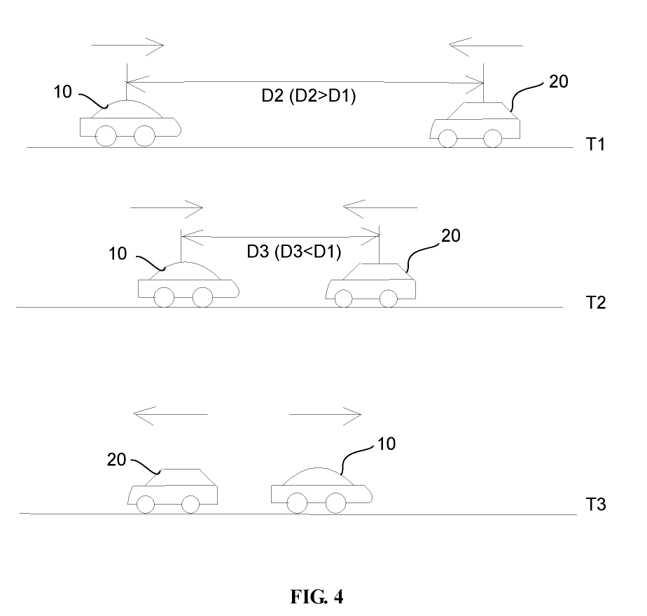

FIG. 4 schematically illustrates a scenario of head passing at different time points T1, T2 and T3. In some embodiments, controlling the headlights of the first vehicle 10 may be only implemented when the distance is less than a threshold distance D1. As shown in FIG. 4, at T1, the distance D2 between the first vehicle 10 and the second vehicle 20 is larger than the threshold distance D1 (D2>D1), in this case, S205 will not be performed. At T2, as the first vehicle 10 and the second vehicle 20 are approaching each other, the distance D3 therebetween is less than the threshold distance D1 (D2<D1). In this case, S205 will be performed. For example, the headlights may be changed from high beams to low beams. Or, the light intensity may be decreased as the distance becomes shorter. In some embodiments, the threshold distance may be set to be 150 m. At T3, as the first vehicle 10 and the second vehicle 20 are running away from each other in opposite directions, there is no need to control the headlight based on the distance between the first vehicle 10 and the second 20 anymore. Therefore, the processing device 103 may no longer generate control instructions based on the distance.

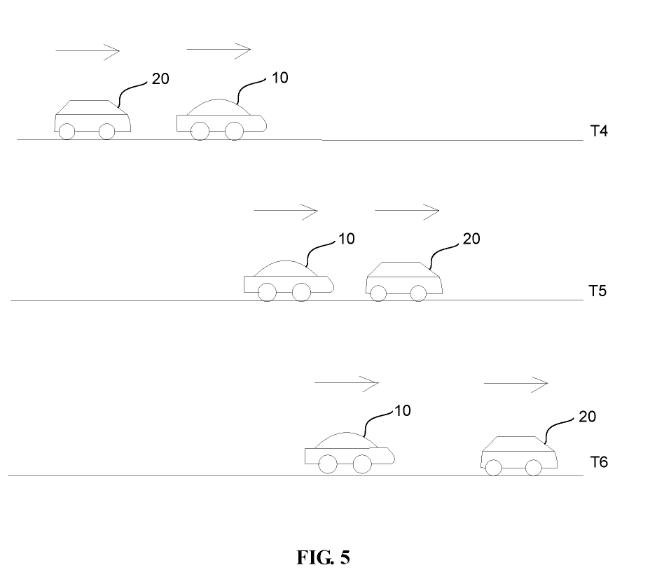

FIG. 5 schematically illustrates a scenario of rear driving at different time points T4, T5 and T6. At T4, the second vehicle 20 is still behind the first vehicle 10, so there is no need to control the headlight based on the distance between the first vehicle 10 and the second vehicle 20. At T5, the second vehicle 20 runs in front of the first vehicle 10, and the processing device 103 may start controlling the actuating device 105. At T6, the second vehicle 20 is in front and far away from the first vehicle 10, so the processing device 103 may stop generating the instruction based on the distance.

In some embodiments, when the heading direction relationship is head passing, the headlight of the first vehicle 10 may be controlled further based on positions of eyes of a driver of the second vehicle 20, so as to prevent light beams emitted from the headlights of the first vehicle 10 reaching the eyes of the driver of the second vehicle 20. The positions of the eyes of the driver of the second vehicle 20 may be estimated based on size and type information of the second vehicle 20 received over the V2V communications network.

In some embodiments, when the heading direction relationship is rear driving, the headlights of the first vehicle 10 may be controlled based on positions of rearview mirrors of the second vehicle 20, so as to prevent the light beams emitted from the headlights of the first vehicle 10 reaching the rearview mirrors of the second vehicle 20. Positions of the rearview mirrors of the second vehicle 20 may be also estimated based on the size and type information of the second vehicle 20 received over the V2V communications network.

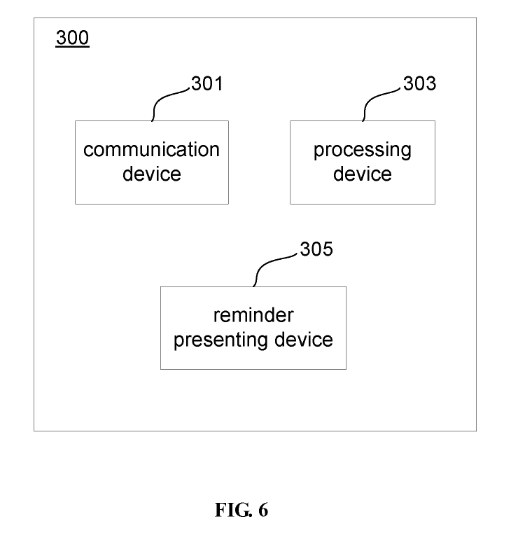

Referring to FIG. 6, a system 300 for controlling vehicle headlights is illustrated. The system 300 may be mounted on the first vehicle 10 for controlling headlights of the first vehicle 10 based on information of the second vehicle 20 received over the V2V communications network.

The system 300 includes: a communication device 301 which is adapted to receiving information of the second vehicle 20 over a V2V communications network; a processing device 303 which is configured to generate a reminder of turning off high beams of headlights of the first vehicle 10 if a distance and a heading direction relationship between the first vehicle 10 and the second vehicle 20 meet a pre-set criteria; and a reminder presenting device 105 which is adapted to present a reminder to a driver of the first vehicle according to the reminder generated.

Hereafter a process for controlling the headlight of the first vehicle 10 will be illustrated in detail, which may be implemented by the system 300. Detail configurations of the system 300 will be more clear with reference to the following descriptions.

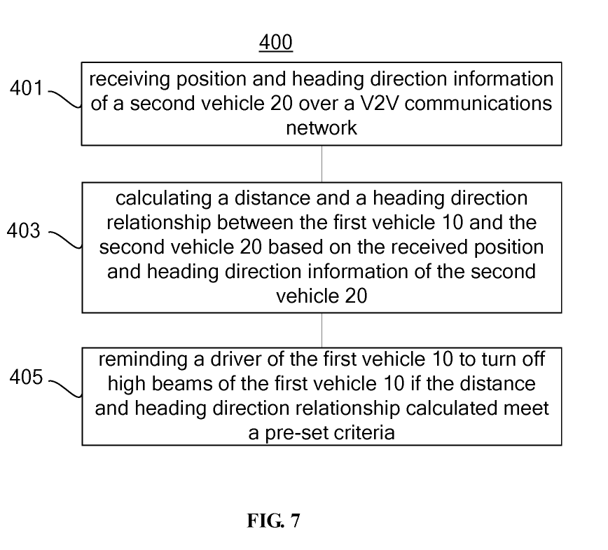

FIG. 7 schematically illustrates a process 400 for controlling the headlights of the first vehicle 10 according to one embodiment.

Referring to FIG. 7, in S401, receiving position and heading direction information of a second vehicle 20 over a V2V communications network.

In some embodiments, receiving the position and heading direction information may be implemented by the communication device 301 (as shown in FIG. 6).

In S403, calculating a distance and a heading direction relationship between the first vehicle 10 and the second vehicle 20 based on the received position and heading direction information of the second vehicle 20.

In some embodiments, S403 may be implemented by way as illustrated above referring S203.

In S405, reminding a driver of the first vehicle 10 to turn off high beams of the first vehicle 10 if the distance and heading direction relationship calculated meet a pre-set criteria.

In some embodiments, the pre-set criteria may include a pre-set distance and a preset heading direction relationship between the first vehicle 10 and the second vehicle 20.

In some embodiments, reminding the driver of the first vehicle 10 to turn off the high beams of the first vehicle 10 may be implemented by the reminder presenting device 305 (as shown in FIG. 6). As such, the reminder presenting device system 305 may present a reminder to the driver of the first vehicle 10 to turn off the high beams of first vehicle 10 through audio.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for controlling vehicle headlights, comprising:
controlling headlights of a first vehicle based on position and heading direction information of vehicles in the vicinity of the first vehicle received over a vehicle to vehicle communications network.

2. The method according to claim 1, further comprising:
controlling the headlights of the first vehicle if a second vehicle, whose position and heading direction relative to the first vehicle meets a pre-set criteria, is identified based on the received position and heading direction information.

3. The method according to claim 2, further comprising:
turning off high beams of the first vehicle if the second vehicle is identified meeting the pre-set criteria.

4. The method according to claim 3, further comprising:
turning on low beams of the first vehicle when the high beams of the first vehicle are turned off.

5. The method according to claim 2, further comprising:
controlling emitting directions of high beams of the first vehicle based on a distance between the first vehicle and the second vehicle if the second vehicle is identified meeting the pre-set criteria, wherein the distance is calculated based on the position information of the second vehicle received over the vehicle to vehicle communications network and position information of the first vehicle.

6. The method according to claim 2, wherein the pre-set criteria comprises a pre-set distance and a pre-set heading direction relationship between the first vehicle and the second vehicle.

7. The method according to claim 2, further comprising:
controlling high beams of the first vehicle based on size and type information of the second vehicle received over the vehicle to vehicle communications network.

8. The method according to claim 7, further comprising:
controlling emitting directions of the high beams of the first vehicle based on positions of eyes of a driver of the second vehicle or positions of rearview mirrors of the second vehicle, which are estimated by the size and the type information of the second vehicle.

9. The method of claim 1, further comprising:
reminding a driver of the first vehicle to turn off high beams when a second vehicle, whose position and heading direction relative to the first vehicle meets a pre-set criteria, is identified based on the position and heading direction information of vehicles in the vicinity of the first vehicle received over the vehicle to vehicle communications network.

10. The method according to claim 9, wherein the pre-set criteria comprises a pre-set distance and a pre-set heading direction relationship between the first vehicle and the second vehicle.

11. A system for controlling vehicle headlights, comprising:
a communication device, and a processing device, wherein the communication device is for receiving position and heading direction information of vehicles in the vicinity of a first vehicle over a vehicle to vehicle communications network, and the processing device is configured to:
control headlights of the first vehicle based on the received position and heading direction information.

12. The system according to claim 11, wherein the processing device is further configured to:
control the headlights of the first vehicle if a second vehicle, whose position and heading direction relative to the first vehicle meets a pre-set criteria, is identified based on the received position and heading direction information.

13. The system according to claim 12, wherein the processing device is further configured to:
control to turn off high beams of the first vehicle if the second vehicle is identified meeting the pre-set criteria.

14. The system according to claim 13, wherein the processing device is further configured to:
control to turn on low beams of the first vehicle when the high beams of the first vehicle are turned off.

15. The system according to claim 12, wherein the processing device is further configured to:
control emitting directions of high beams of the first vehicle based on a distance between the first vehicle and the second vehicle if the second vehicle is identified meeting the pre-set criteria, wherein the distance is calculated based on the position information of the second vehicle received over the vehicle to vehicle communications network and position information of the first vehicle.

16. The system according to claim 12, wherein the pre-set criteria comprises a pre-set distance and a pre-set heading direction relationship between the first vehicle and the second vehicle.

17. The system according to claim 12, wherein the processing device is further configured to:
control the headlights of the first vehicle based on size and type information of the second vehicle received, by the communication device, over the vehicle to vehicle communications network.

18. The system according to claim 17, wherein the processing device is further configured to:
control emitting directions of high beams of the first vehicle based on positions of eyes of a driver of the second vehicle or positions of rearview mirrors of the second vehicle, which are estimated by the size and the type information of the second vehicle.

19. A system for reminding driver to turn off high beams, comprising a communication device, a reminder presenting device system, and a processing device, wherein the communication device is for receiving position and heading direction information of vehicles in the vicinity of a first vehicle over a vehicle to vehicle communications network, and the processing device is configured to:
control the reminder presenting device to present a reminder to a driver of a first vehicle to turn off high beams when a second vehicle, whose position and heading direction relative to the first vehicle meets a pre-set criteria, is identified based on received position and heading direction information.

20. The system according to claim 19, wherein the pre-set criteria comprises a pre-set distance and a pre-set heading direction relationship between the first vehicle and the second vehicle.
